(19) United States
(12) Patent Application Publication
(10) Pub. No.: US 2026/0189871 A1
(43) Pub. Date: Jul. 2, 2026

(54) Low-Latency Dynamic Spatial Audio

(71) Applicant: Google LLC, Mountain View, CA (US)

(72) Inventor: Sunil Kumar, Santa Clara, CA (US)

(21) Appl. No.: 19/130,795

(22) PCT Filed: Feb. 22, 2023
(86) PCT No.: PCT/US2023/013595

§ 371 Date: May 16, 2025

Related U.S. Application Data
(60) Provisional application No. 63/426,265, filed on Nov. 17, 2022.

(51) Int. Cl. H04S 7/00; H04R 1/10

(52) U.S. Cl. CPC H04S 7/304; H04R 1/1041; H04R 2420/07

(57) ABSTRACT

Features described herein generally relate to providing dynamic spatial audio. Particularly, audio data is received, first audio frames are generated from the received audio data, the audio frames are transmitted to an audio playback device using a wireless link in a dynamic spatial audio mode, at least one condition associated with the audio playback device is detected, second audio frames are generated from the received audio data; and the second audio frames is transmitted to the audio playback device using the wireless link in a basic audio mode.

### CROSS-REFERENCE TO RELATED APPLICATIONS

This application is based upon and claims the right of priority under 35 U.S.C. § 371 to International Application No. PCT/US2023/013595, filed Feb. 22, 2023, and titled “LOW-LATENCY DYNAMIC SPATIAL AUDIO,” which claims the benefit of and priority to U.S. Provisional Application No. 63/426,265, filed Nov. 17, 2022, and titled “LOW-LATENCY DYNAMIC SPATIAL AUDIO.” Applicant claims priority to and the benefit of each of such applications and incorporates all such applications herein by reference in their entirety.

### FIELD

The present disclosure generally relates to electronic devices. Particularly, the present disclosure relates to low-latency dynamic spatial audio.

### BACKGROUND

Wireless audio playback devices such as earbuds offer a convenient way for users of electronic devices to listen to audio. In some cases, the audio is basic audio (e.g., stereo audio) or static spatial audio (e.g., immersive audio) in which the audio can be perceived by the user as emanating from one or more sources that move in space with respect to movements of the user's head. In other cases, the audio is dynamic spatial audio (e.g., immersive audio with head tracking) in which the audio is perceived by the user as emanating from one or more sources that do not move in space with respect to movements of the user's head. Users have found listening to dynamic spatial audio to be a pleasurable experience because they can feel as if they are completely immersed in the audio. However, due to latency requirements, providing a pleasurable dynamic spatial audio experience with wireless audio playback devices is challenging.

### SUMMARY

Embodiments described herein pertain to low-latency dynamic spatial audio.

According to some embodiments, a method for providing dynamic spatial audio includes receiving audio data; switching to a dynamic spatial audio mode; while in the dynamic spatial audio mode: set a buffer in the audio playback device to buffer a first amount of audio; generating first audio frames from the received audio data; transmitting the audio frames to an audio playback device using a wireless link; and detecting at least one condition associated with the audio playback device; in response to detecting the at least one condition associated with the audio playback device, switching to a basic audio mode; while in the basic audio mode: set the buffer in the audio playback device to buffer a second amount of audio more than the first amount of audio; generating second audio frames from the received audio data; and transmitting the second audio frames to the audio playback device using the wireless link.

In some embodiments, wherein the at least one condition corresponds to tracking data not being received, a poor wireless link, or an empty buffer.

In some embodiments, wherein the audio playback device comprises orientation detection circuitry.

In some embodiments, wherein the audio playback device comprises at least one earbud.

In some embodiments, wherein the wireless link comprises at least one of a Bluetooth basic rate/enhanced data rate link and a Bluetooth low energy audio link.

In some embodiments, wherein the first audio frames are generated in the dynamic spatial audio mode at a first predetermined rate, and wherein transmitting the audio frames to the audio playback device using the wireless link in the dynamic spatial audio mode comprises pinging the audio playback device as at a second predetermined rate faster than the first predetermined rate.

In some embodiments, wherein the first audio frames are generated in the dynamic spatial audio mode at a first predetermined rate, and wherein transmitting the audio signal to the audio playback device using the wireless link in the basic audio mode comprises transmitting bursts of audio frames to the audio playback device at a third predetermined rate that is slower than the first predetermined rate.

According to some embodiments, a system for providing dynamic spatial audio includes one or more processors and one or more memories, where the one or more memories store instructions which, when executed by the one or more processors, cause the one or more processors to perform part or all of the operations and/or methods disclosed herein. Some embodiments of the present disclosure also include one or more non-transitory computer-readable media storing computer-readable instructions that, when executed by one or more processors, cause the one or more processors to perform part or all of the operations and/or the methods disclosed herein.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates an embodiment of an example scenario of a user listening to basic audio/static spatial audio according to some aspects of the present disclosure.

FIG. 1B illustrates an embodiment of an example scenario of a user listening to dynamic spatial audio according to some aspects of the present disclosure.

FIG. 2 illustrates an embodiment of an example system for providing dynamic spatial audio according to some aspects of the present disclosure.

FIG. 3 illustrates an embodiment of an example process for providing dynamic spatial audio according to some aspects of the present disclosure.

FIG. 4 illustrates an embodiment of example process of a basic audio mode according to some aspects of the present disclosure.

FIG. 5 illustrates an embodiment of an example operation in a basic audio mode according to some aspects of the present disclosure.

FIG. 6 illustrates an embodiment of example process of a dynamic spatial audio mode according to some aspects of the present disclosure.

FIG. 7 illustrates an embodiment of an example operation in a dynamic spatial audio mode according to some aspects of the present disclosure.

### DETAILED DESCRIPTION

A user of an electronic device such as a mobile phone may listen to dynamic spatial audio on a wireless playback device such as earbuds that are connected to the electronic device. For the user to feel truly immersed in the audio, the sound output by the earbuds should react to the user's head movements. That is, as the user moves their head while listening to the dynamic spatial audio, the electronic device should adjust the sound output by the earbuds in accordance with the user's head movements. For example, if the user turns their head to the left side and looks up, the electronic device should transmit the dynamic spatial audio to the earbuds such that sound perceived as emanating from the left side of and above the user's head can be reproduced with increased volume from which it was previously reproduced while sound perceived as emanating from the right side of and below the user's head can be reproduced with decreased volume from which it was previously reproduced.

Typically, earbuds include circuitry such as an inertial measurement unit (IMU) that can track the user's head movements and a Bluetooth® (BT) communication module that can transmit tracking data to the electronic device. However, due to latencies introduced within the electronic device, by the communication channel between the electronic device and earbuds, and within the earbuds, the audio that is reproduced by the earbuds may not be synchronized with the user's head movements. The operations and/or methods disclosed herein overcome this challenge and others by enabling the electronic device to provide low-latency dynamic spatial audio. With the features described herein, audio playback synchronization can be improved, playback interruptions can be minimized, and communication throughput of the electronic device can be improved.

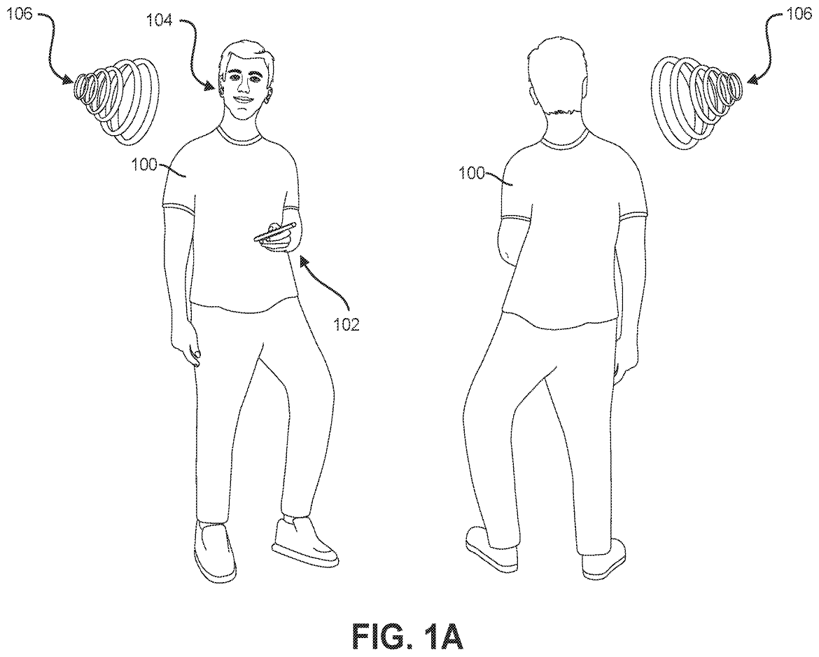

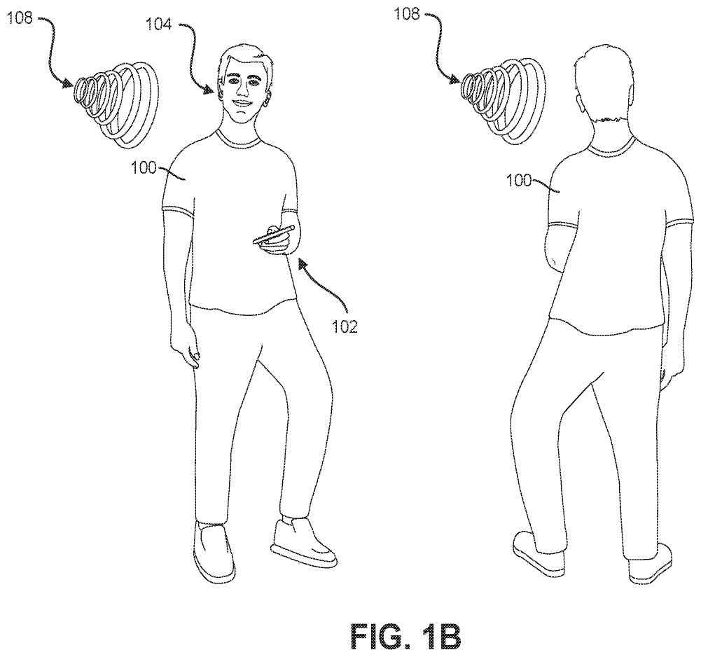

As shown in FIGS. 1A and 1B, a user 100 of an electronic device 102 can connect the electronic device 102 to earbuds 104 that are worn by the user 100 and listen to audio transmitted from the electronic device 102 to the earbuds 104. In some embodiments, the audio can be basic audio (e.g., stereo audio) or static spatial audio (e.g., immersive audio) in which the audio is perceived by the user as emanating from one or more sources that move in space with respect to movements of the user's 100 head. For example, as shown in FIG. 1A, an audio source 106 perceived by the user 100 to be located to the right side of the user's 100 head when the user's 100 head is facing a first direction is still perceived by the user 100 to be located to the right side of the user's 100 head even when the user's 100 head is facing a second direction. In other words, the location of the audio source 106 in space can be anchored to the user's 100 head. In some embodiments, the audio can be dynamic spatial audio (e.g., immersive audio with head tracking) in which the audio is perceived by the user as emanating from one or more sources that do not move in space with respect to movements of the user's 100 head. For example, as shown in FIG. 1B, an audio source 108 perceived by the user 100 to be located to the right side of the user's 100 head when the user's 100 head is facing a first direction is perceived by the user 100 to be located to the left side of the user's 100 head when the user's 100 head is facing a second direction. In other words, the location of the audio source 108 in space can be anchored to a position in the space.

In some embodiments, the electronic device can determine whether any audio data is available for playback and whether that audio data corresponds to basic audio or spatial audio (e.g., static spatial audio and/or dynamic spatial audio). In the case of basic audio, the electronic device can set a basic audio mode for playback. In some embodiments, the electronic device can determine whether an audio playback device is connected to the electronic device and includes an orientation detector. In the case of spatial audio and the audio playback device including an orientation detector, the electronic device can set a dynamic spatial audio mode for playback.

In the basic audio mode, a buffer in the audio playback device can buffer a first amount of audio. The electronic device can generate audio frames for audio that is available for playback and transmit bursts of audio frames to the audio playback device. The audio frames can be generated at a first rate and the bursts of audio frames can be transmitted at a second rate. The first rate can be faster than the second rate. Additionally, the electronic device can determine whether the audio data corresponds to spatial audio (e.g., static spatial audio and/or dynamic spatial audio) and switch to the dynamic spatial audio mode. Otherwise, the electronic device can continue playback in the basic audio mode. In the basic audio mode, by buffering a first amount of audio and transmitting bursts of audio frames at a rate slower than a rate at which the audio frames are generated, playback interruptions can be minimized and communication throughput of the electronic device can be improved.

In the dynamic spatial audio mode, a buffer in the audio playback device can buffer a second amount of audio. The second amount of audio can be less than the first amount of audio. The electronic device can generate audio frames for the audio that is available for playback and periodically ping the audio playback device with generated audio frames or empty frames. The audio frames can be generated at the first rate and the audio playback device can be pinged at a third rate that is faster than the first rate. The audio playback device can generate tracking data at a fourth rate that is faster than the first rate and the third rate. In response to receiving a generated audio frame or an empty frame, the audio playback device can transmit the generated tracking data to the electronic device. Additionally, the electronic device can detect a condition associated with the audio playback device. For example, the electronic device can detect whether tracking data has been received from the audio playback device in response to a ping of the audio playback device, the wireless link between the electronic device and the audio playback device is good, and the audio playback device buffer is empty. The electronic device can switch to the basic audio mode in response to detecting at least one of those conditions. Otherwise, the electronic device can continue playback in the dynamic spatial audio mode. In the dynamic spatial audio mode, by buffering a second amount of audio and periodically pinging the audio playback device, audio playback synchronization can be improved, playback interruptions can be minimized, and communication throughput of the electronic device can be improved.

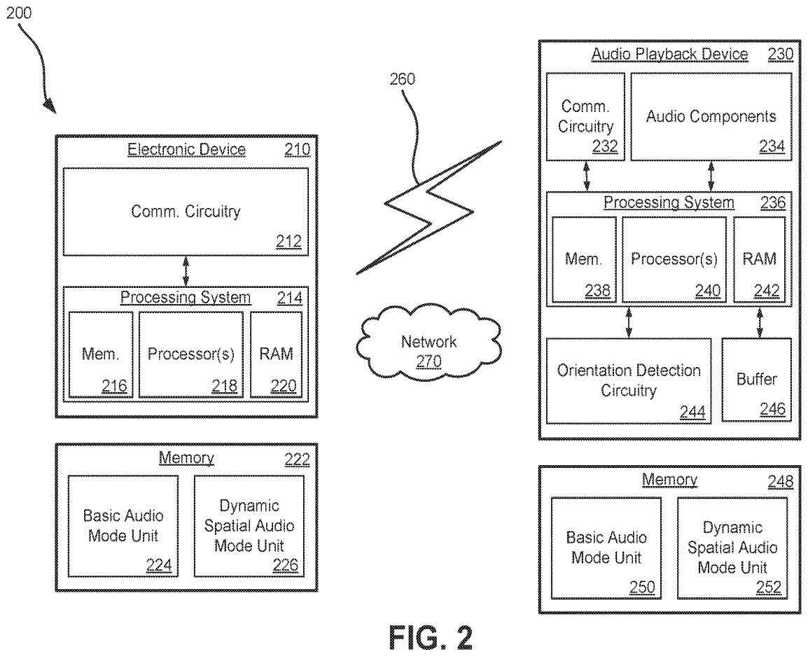

FIG. 2 shows an embodiment of an example system 200 for dynamically providing non-spatial and spatial audio. As shown in FIG. 2, the system 200 includes an electronic device 210 that includes communications circuitry 212 and a processing system 214.

Communications circuitry 212 may be configured to enable the electronic device 210 to communicate with and send and receive data and other information over wired or wireless networks such as network 270. Communications circuitry 212 may also be configured to enable the electronic device 210 to communicate with and send and receive data and other information over wired or wireless communication channels such as wireless link 260. Communications circuitry 212 may also be configured to enable the electronic device 210 to communicate with, send data and other information to, and receive data and other information from other systems and devices such as an audio playback device 230.

Examples of communications circuitry 212 include BT modules and chips (e.g., BT basic rate/enhanced data rate and/or a BT low energy audio modules and chips); wireless communication modules and chips; wired communication modules and chips; chips for communicating over local area networks, wide area networks, cellular networks, satellite networks, fiber optic networks, Internet networks, and the like; a system on a chip; Near Field Communication (NFC) modules and chips; radio frequency identification (RFID) modules and chips; and/or other circuitry that enables the electronic device 210 to send and receive data over a wired or wireless networks and/or communication channels.

The electronic device 210 also includes processing system 214. Processing system 214 may be configured to provide dynamic spatial audio in accordance with a part or all of the operations and/or methods disclosed herein. The processing system 214 includes one or more memories 216, one or more processors 218, and random-access memory (RAM) 220. The one or more processors 218 can read one or more programs from the one or more memories 216 and execute them using RAM 220. In some embodiments, the one or more programs are configured to enable to the electronic device 210 to provide dynamic spatial audio in accordance with a part or all of the operations and/or methods disclosed herein. The one or more processors 218 may be of any type including but not limited to a microprocessor, a microcontroller, a central processing unit (CPU), a graphical processing unit (GPU), a digital signal processor (DSP), an application-specific integrated circuit (ASIC), a field programmable gate array (FPGA), or any combination thereof. In some embodiments, the one or more processors 218 may include a plurality of cores, a plurality of arrays, one or more coprocessors, and/or one or more layers of local cache memory.

The one or more memories 216 can be non-volatile and may include any type of memory device that retains stored information when powered off. Non-limiting examples of memory include electrically erasable and programmable read-only memory (EEPROM), flash memory, or any other type of non-volatile memory. At least one memory of the one or more memories 216 can include a non-transitory computer-readable storage medium from which the one or more processors 218 can read instructions. A computer-readable storage medium can include electronic, optical, magnetic, or other storage devices capable of providing the one or more processors 218 with computer-readable instructions or other program code. Non-limiting examples of a computer-readable storage medium include magnetic disks, memory chips, read-only (ROM), RAM, an ASIC, a configured processor, optical storage, or any other medium from which a computer processor can read the instructions.

In some embodiments, the one or more memories 216 include memory 222. Memory 222 can include a basic audio mode unit 224 and a dynamic spatial audio mode unit 226. The basic audio mode unit 224 is configured to set and operate the electronic device 210 in the basic audio mode (to be described later) when basic audio and/or static spatial audio is available for playback with the audio playback device 230. The dynamic spatial audio mode unit 226 is configured to set and operate the electronic device 210 in the dynamic spatial audio mode (to be described later) when dynamic spatial audio is available for playback with the audio playback device 230.

Although not shown, electronic device 210 may also include other components such as display circuitry, audio circuitry, orientation detection circuitry, power circuitry, storage devices, and other input and output (I/O) components.

The display circuitry may include one or more liquid crystal displays (LCD), light emitting diode (LED) displays, organic LED (OLED) displays, digital light projector (DLP) displays, liquid crystal on silicon (LCoS) displays, touchscreen displays, and/or other devices that are suitable for presenting visualizations and/or information to one or more users and receiving input from the one or more users.

The audio circuitry may include one or more microphones, speakers, and/or other audio and sound transducer devices that are suitable for recording, processing, storing, and outputting audio and other sounds.

The orientation detection circuitry may include one or more IMUs, accelerometers, gyroscopes, motion sensors, tilt sensors, inclinometers, angular velocity sensors, gravity sensors, magnetometers, compasses, satellite navigation devices such as global positioning system (GPS) devices, indoor localization devices such as ultra-wideband (UWB) transmitters and receivers, light detection and ranging (LiDAR) localization devices, radio detection and ranging (RADAR) localization devices, wireless fidelity (WiFi) localization devices, microwave localization devices, and BT localization devices. Other examples of orientation detection circuitry include other devices that are suitable for determining an indoor position, an outdoor position, an orientation, and a posture of the electronic device and one or more users of the electronic device 210 and determining a range between the electronic device 210 and one or more other devices.

The power circuitry may include batteries, power supplies, charging circuits, solar panels, and/or other devices that can generate power and/or receive power from a source external to the electronic device 210 and power the electronic device 210 with the generated and/or received generated power.

The removable storage and non-removable storage devices may include magnetic disk devices such as hard disk drives (HDDs), optical disk drives such as compact disk (CD) drives and digital versatile disk (DVD) drives, solid-state drives (SSDs), and tape drives.

The input components may include a mouse, a keyboard, a trackball, a touch pad, a touchscreen display, a stylus, a data glove, and the like. Additionally, the output component may include a holographic display, a three-dimensional (3D) display, a projector, and the like.

The foregoing description of the electronic device 210 is not intended to be limiting and the electronic device 210 may include fewer components or additional components than those described above.

Continuing to reference FIG. 2, the system 200 also includes an audio playback device 230 that includes communications circuitry 232, audio output component 234, processing system 236, orientation detection circuitry 244, and buffer 246.

Communications circuitry 232 may be configured to enable the audio playback device 230 to communicate with and send and receive data and other information over wireless networks such as network 270. Communications circuitry 232 may also be configured to enable the audio playback device 230 to communicate with and send and receive data and other information over wireless communication channels such as wireless link 260. Communications circuitry 232 may also be configured to enable the audio playback device 230 to communicate with, send data and other information to, and receive data and other information from other systems and devices such as the electronic device 210.

Examples of communications circuitry 232 include BT modules and chips (e.g., BT basic rate/enhanced data rate and/or a BT low energy audio modules and chips); wireless communication modules and chips; wired communication modules and chips; chips for communicating over local area networks, wide area networks, cellular networks, satellite networks, fiber optic networks, Internet networks, and the like; a system on a chip; Near Field Communication (NFC) modules and chips; radio frequency identification (RFID) modules and chips;
and/or other circuitry that enables the audio playback device 230 to send and receive data over wireless networks and/or communication channels.

Audio components 234 may be configured to record sounds from a surrounding environment of the audio playback device 230 and output sounds to one or more users of the audio playback device 230, a surrounding environment of the audio playback device 230, and the electronic device 210. Audio output component 234 may include one or more components that convert one or more signals into one or more sounds. For example, audio output component 234 may include one or more microphones, speakers, transducers, and/or other components that are capable of transducing or converting signals into sounds and sounds into signals.

The audio playback device 230 also includes processing system 236. Processing system 236 may be configured to provide dynamic spatial audio in accordance with a part or all of the operations and/or methods disclosed herein. The processing system 236 includes one or more memories 238, one or more processors 240, and RAM 242. The one or more processors 240 can read one or more programs from the one or more memories 238 and execute them using RAM 242. In some embodiments, the one or more programs are configured to enable to the audio playback device 230 to provide dynamic spatial audio in accordance with a part or all of the operations and/or methods disclosed herein. The one or more processors 240 may be of any type including but not limited to a microprocessor, a microcontroller, a CPU, a GPU, a DSP, an ASIC, a FPGA, or any combination thereof. In some embodiments, the one or more processors 240 may include a plurality of cores, a plurality of arrays, one or more coprocessors, and/or one or more layers of local cache memory.

The one or more memories 238 can be non-volatile and may include any type of memory device that retains stored information when powered off. Non-limiting examples of memory include EEPROM, flash memory, or any other type of non-volatile memory. At least one memory of the one or more memories 238 can include a non-transitory computer-readable storage medium from which the one or more processors 240 can read instructions. A computer-readable storage medium can include electronic, optical, magnetic, or other storage devices capable of providing the one or more processors 240 with computer-readable instructions or other program code. Non-limiting examples of a computer-readable storage medium include magnetic disks, memory chips, ROM, RAM, an ASIC, a configured processor, optical storage, or any other medium from which a computer processor can read the instructions.

In some embodiments, the one or more memories 238 include memory 248. Memory 248 can include a basic audio mode unit 250 and a dynamic spatial audio mode unit 252. The basic audio mode unit 250 is configured to operate the audio playback device 230 in the basic audio mode (to be described later) when the electronic device 210 sets the basic audio mode and transmits audio frames to the audio playback device 230 while the audio playback device 230 is in the basic audio mode. The dynamic spatial audio mode unit 252 is configured to operate the audio playback device 230 in the dynamic spatial audio mode (to be described later) when the electronic device 201 sets the dynamic spatial audio mode and transmits audio frames to the audio playback device 230 while the audio playback device 230 is in the dynamic spatial audio mode.

The audio playback device 230 also includes orientation detection circuitry 244. Orientation detection circuity 244 may be configured to determine an orientation, an attitude, a posture, a location, and/or a position of one or more users of the audio playback device 230 and the audio playback device 230. The orientation detection circuitry 244 may also be configured to determine a range between the audio playback device 230 and other devices such as electronic device 210.

Examples of orientation detection circuitry 244 include one or more IMUs, accelerometers, gyroscopes, motion sensors, tilt sensors, inclinometers, angular velocity sensors, gravity sensors, magnetometers, compasses, satellite navigation devices such as GPS devices, indoor localization devices such as UWB transmitters and receivers, LiDAR localization devices, RADAR localization devices, WiFi localization devices, microwave localization devices, and BT localization devices. Other examples of orientation detection circuitry 244 include other devices that are suitable for determining an orientation, an attitude, a posture, a location, and/or a position of one or more users of the audio playback device 230 and the audio playback device 230 and determining a range between the audio playback device 230 and other devices such as electronic device 210.

The audio playback device 230 also includes a buffer 246. The buffer 246 may be configured to store audio data and other information received from and/or generated by the electronic device 210. The buffer 246 may be a ring buffer, a circular buffer, a cyclic buffer, a jitter buffer, and the like.

Although not shown, audio playback device 230 may also include other components such as display circuitry and power circuitry.

The display circuitry may include one or more LCDs, LED displays, OLED displays, DLP displays, LCoS displays, touchscreen displays, and/or other devices that are suitable for presenting visualizations and/or information to one or more users and receiving input from the one or more users.

The power circuitry may include batteries, power supplies, charging circuits, solar panels, and/or other devices that can generate power and/or receive power from a source external to the audio playback device 230 and power the audio playback device 230 with the generated and/or received generated power.

The foregoing description of the audio playback device 230 is not intended to be limiting and the audio playback device 230 may include fewer components or additional components than those described above.

As described above, system 200 includes a wireless link 260 and a network 270 that enables the electronic device 210 and the audio playback device 230 to communicate with each other. For example, the wireless link 260 and/or the network 270 enables the electronic device 210 to send audio data and other information to audio playback device 230 and receive tracking data and other information from the audio playback device 230. In some embodiments, the electronic device 210 and the audio playback device 230 may form part of a BT piconet. In other embodiments, the electronic device 210 and the audio playback device 230 may form part of a local area network (LAN), a wide area network (WAN), a virtual private network (VPN), a peer-to-peer (P2P) network, and the like. In some embodiments, the network may be an encrypted and/or unencrypted network.

The system 200 has been described with respect to an electronic device 210 and an audio playback device 230. However, the system 200 may include additional and/or different components. For example, additional electronic devices that are configured similar to electronic device 210 may communicate with, send data and other information to, and receive data and other information from audio playback device 230 in accordance with a part or all of the operations and/or methods disclosed herein. Additionally, audio playback device 230 may form part of a set of audio playback devices that are configured similar to audio playback device 230 and may communicate with, send data and other information to, and receive data and other information from electronic device 210 and audio playback device 230 in accordance with a part or all of the operations and/or methods disclosed herein.

The electronic device 210 may be implemented as a communication device (e.g., a smart, cellular, mobile, wireless, portable, and/or radio telephone, etc.); a home automation controller (e.g., alarm system, thermostat, control panel, door lock, smart hub, etc.); a home appliance device (e.g., a smart speaker, television, a streaming stick or device, home theater system, refrigerator, dishwasher, washer, dryer, oscillating fan, ceiling fan, smart lights, etc.); a gaming device (e.g., gaming controller, data glove, etc.); a vehicle (e.g., a robotic, self-driving, autonomous vehicle, etc.), and/or other portable computing device (e.g., a tablet, phablet, notebook, and laptop computer; a personal digital assistant; display hub; etc.). In other embodiments, the electronic device 210 may be implemented as a wearable device (e.g., a smart watch, fitness tracker, smart eyeglasses, head-mounted device, smart clothing device, etc.) that includes a band such that a user can wear the wearable device on a body part (e.g., their wrist, head, waist, ankle, etc.). Additionally, the electronic device 210 may be implemented as a smart device (i.e., any device that is capable of connecting to other devices through a network and/or the Internet) and/or other computing device that can be configured to dynamically provide non-spatial and spatial audio in accordance with a part or all of the operations and/or methods disclosed herein.

The audio playback device 230 may be implemented as a set of wireless earbuds in an earbud system and/or a wireless speaker. In the case of an earbud system, audio playback device 230 may be a primary earbud and another audio playback device that is configured to similar to audio playback device 230 may be a secondary earbud. In some embodiments, the primary earbud can manage communication to and from electronic device 210 and communication to and from the secondary earbud. In other embodiments, both the primary earbud and secondary earbud can manage communication to and from electronic device 210. In other embodiments, audio playback device 230 may be implemented as wireless headphones, wireless headsets, wireless earphones, and/or any other device that is capable of wireless communicating with an electronic device and reproducing sounds.

As discussed above, an electronic device user may listen to basic audio, static spatial audio, and dynamic spatial audio on a wireless playback device that is connected to the electronic device. However, due to latencies introduced within the electronic device, by the communication channel between the electronic device and audio playback device, and within the audio playback device, dynamic spatial audio that is reproduced by the audio playback device may not be synchronized with user's head movements. With the electronic device and audio playback device described above, audio playback synchronization can be improved, playback interruptions can be minimized, and communication throughput of the electronic device can be improved.

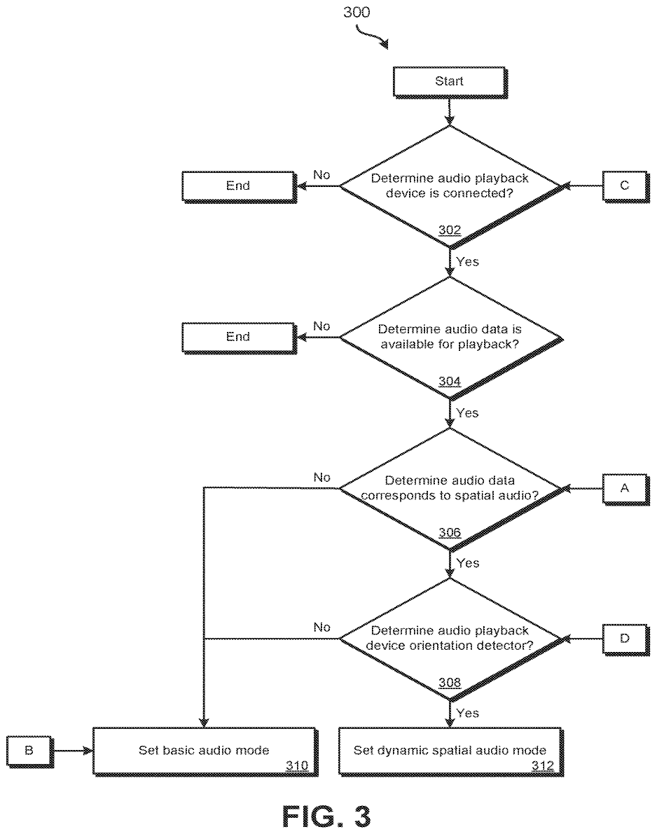

FIG. 3 illustrates an embodiment of an example process 300 for providing dynamic spatial audio. The process 300 can be implemented by system 200. In some embodiments, the process 300 can be implemented by the electronic device 210 or the audio playback device 230. In other embodiments, the process 300 can be implemented by both the electronic device 210 and the audio playback device 230. The process 300 can be implemented in software or hardware or any combination thereof. In some embodiments, the process 300 can be implemented by the basic audio mode units 224, 250 and the dynamic spatial audio mode units 226, 252.

As shown in FIG. 3, to provide dynamic spatial audio, at block 302, an electronic device such as the electronic device 210 can determine whether or not an audio playback device such as audio playback device 230 is connected to the electronic device 210 through a link such as wireless link 260 and/or a network such as network 270. For example, the electronic device 210 may be connected to the audio playback device 230 through a wireless link such as wireless link 260 and/or network 270. In some embodiments, the wireless link may be a BT basic rate/enhanced data rate (BR/EDR) and/or a BT low energy audio (LE Audio) link. Upon determining that the electronic device 210 is connected to the audio playback device 230, at block 304, the electronic device 210 can determine whether or not audio data is available for playback. For example, the electronic device 210 can determine whether or not audio data has been transferred to the electronic device 210 from an external source (e.g., a remote database, Internet, or another device) and/or whether or not audio data has been generated with the electronic device 210 using audio circuitry and the processing system 214 of the electronic device 210. On the other hand, upon determining that an audio playback device is not connected to the electronic device 210, the process can end. Similarly, upon determining that audio data is not available for playback, the process can end.

In some embodiments, the audio data may include a single channel or multiple channels. For the example, the audio data may correspond to mono audio (i.e., monaural or monophonic audio), stereo audio (i.e., stereophonic audio), static spatial audio (i.e., immersive or 3D audio), and/or dynamic spatial audio (i.e., immersive audio with head tracking). In some embodiments, the audio data may be in a pulse-code modulation (PCM) format, waveform audio file format (WAV), audio interchange file format (AIFF), MPEG-1 Audio Layer 3 (MP3) format, advanced audio coding (AAC) format, Windows® media audio (WMA) format, free lossless audio codec (FLAC) format, Apple® lossless audio codec (ALAC) format, and the like. In other embodiments, the audio data may be in a Dolby® Atmos® format, dts®:X format, Sony® 360 Reality Audio format, and the like.

Upon determining that audio data is available for playback, at block 306, the electronic device 210 can determine whether or not the audio data corresponds to basic audio or spatial audio. In some embodiments, the electronic device 210 can determine whether or not the audio data corresponds to spatial audio by determining whether or not the audio data is in a spatial audio format such as those described above. In other embodiments, the electronic device 210 can determine whether or not the audio data corresponds to spatial audio based on metadata and other information included with the audio data. In some embodiments, a user of the electronic device 210 can inform the electronic device 210 that the audio data corresponds to spatial audio.

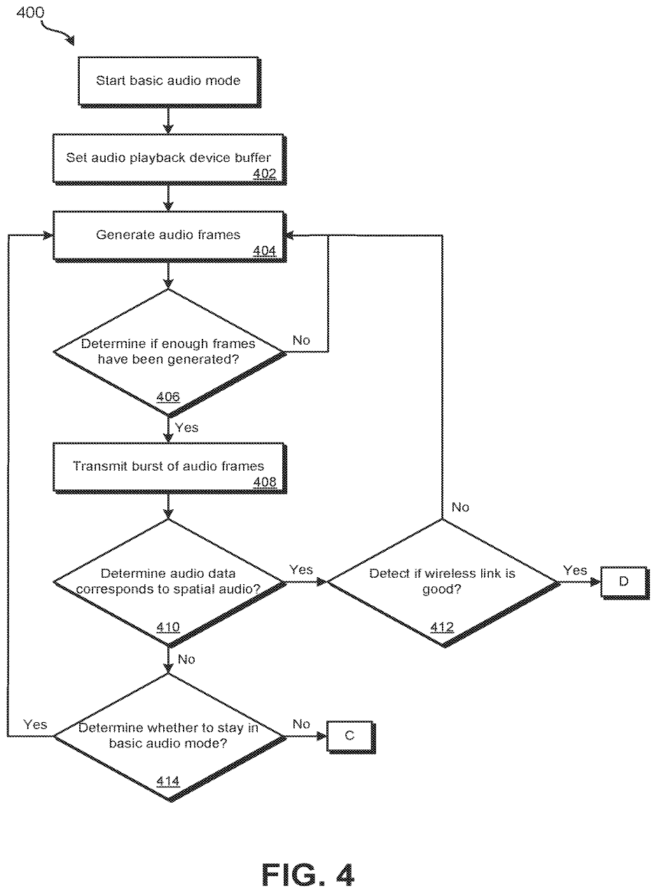

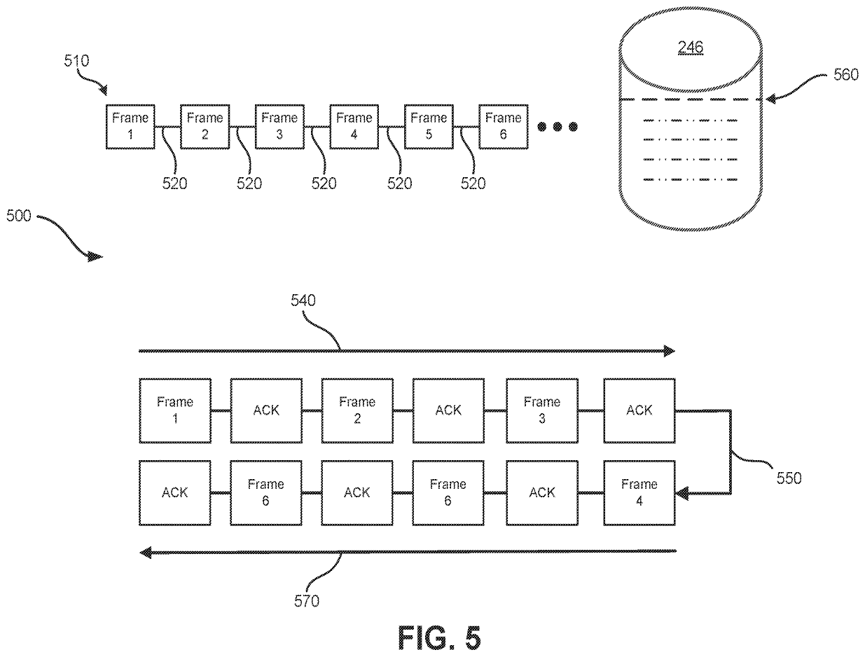

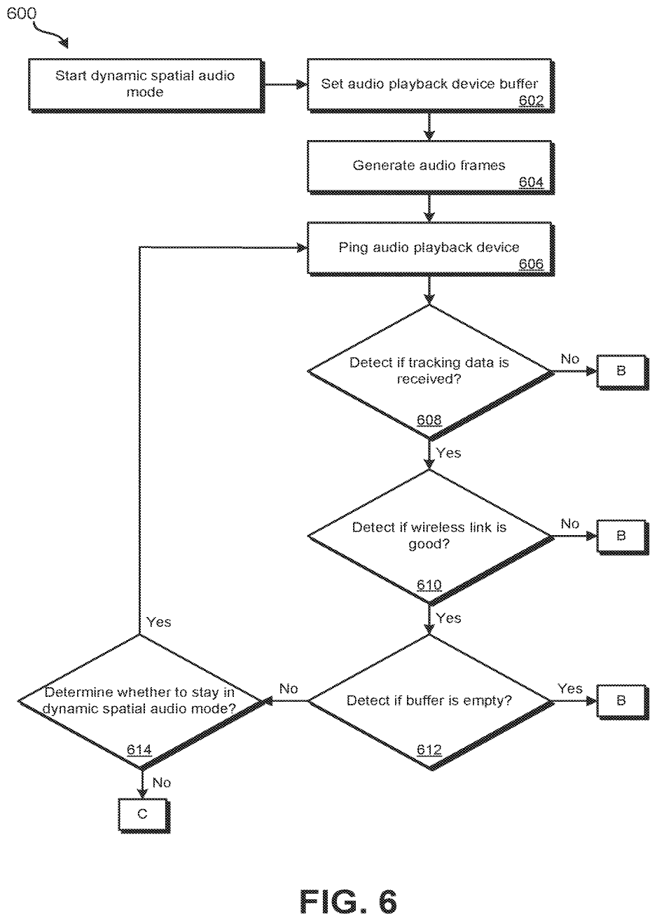

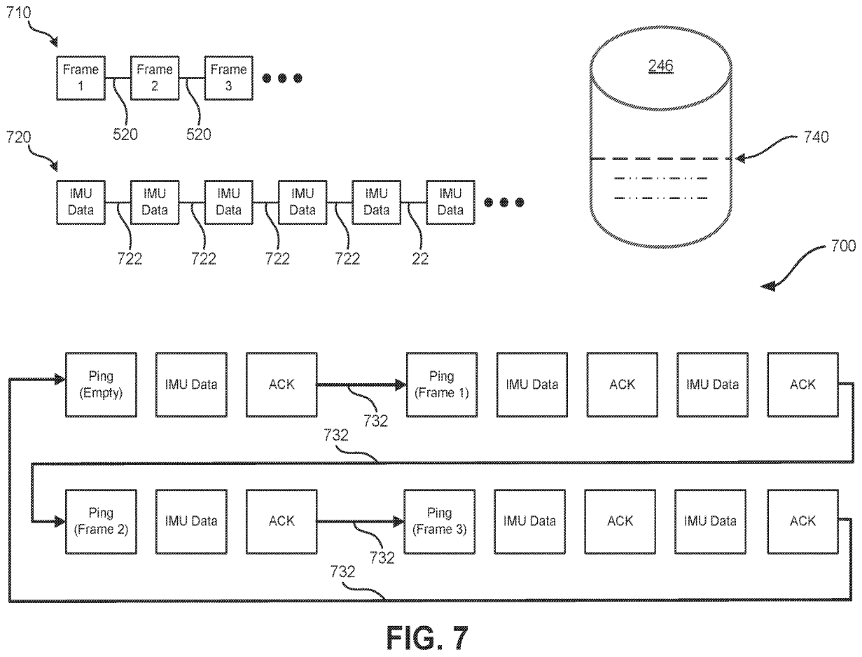

Upon determining that the audio data corresponds to basic audio (i.e., no at block 306), at block 310, the electronic device 210 can be set to and operate in the basic audio mode (FIGS. 4 and 5) in which the audio playback device 230 can playback basic audio. Upon determining that the audio data corresponds to spatial audio data (i.e., yes at block 306), at block 308, the electronic device 210 can determine whether or not the audio playback device 230 includes an orientation detector. In some embodiments, the audio playback device 230 can send data and other information that indicates whether or not the audio playback device 230 includes an orientation detector. In other embodiments, the electronic device 210 can request from the audio playback device 230 and/or another source information indicating whether or not the audio playback device 230 includes an orientation detector. In further embodiments, a user of the electronic device 210 can inform the electronic device 210 whether or not the audio playback device 230 includes an orientation detector. Upon determining that the audio playback device 230 does not include an orientation detector (i.e., no at block 308), at block 310, the electronic device 210 can be set to and operate in the basic audio mode (FIGS. 4 and 5) in which the audio playback device 230 can also playback spatial audio. Upon determining that the audio playback device 230 includes an orientation detector (i.e., yes at block 308), at block 312, the electronic device 210 can be set to and operate in the dynamic spatial audio mode (FIGS. 6 and 7) in which the audio playback device 230 can playback dynamic spatial audio.

FIGS. 4 and 5 respectively illustrate an embodiment of an example process 400 and operation 500 of a basic audio mode according to some aspects. The process 400 and operation 500 can be implemented by system 200. In some embodiments, the process 400 and operation 500 can be implemented by the electronic device 210 or the audio playback device 230. In other embodiments, the process 400 and operation 500 can be implemented by both the electronic device 210 and the audio playback device 230. The process 400 and operation 500 can be implemented in software or hardware or any combination thereof. In some embodiments, the process 400 and operation 500 can be implemented by the basic audio mode units 224, 250 and the dynamic spatial audio mode units 226, 252.

As shown in FIG. 4, in the basic audio mode, at block 402, a buffer such as buffer 246 in the audio playback device 230 is set. In some embodiments, the buffer 246 can be set to buffer a first amount of audio 560. In some embodiments, the first amount of audio 560 can be set such that between 0.25 seconds (250 milliseconds) and 1 second (1,000 milliseconds) of audio can be buffered.

At block 404, audio frames 510 are generated from the audio data that is available for playback. In some embodiments, the audio frames 510 can be generated based on one or more audio encoder/decoders (i.e., audio codecs) such as one or more BT codecs. Examples of such codecs include the Qualcomm® aptX® codec, Qualcomm® aptX® Low Latency codec, Qualcomm® aptX® High Definition codec, Sony® LDAC codec, AAC, Samsung® Ultra High Quality codec, and Low-complexity Subband codec, Modified Low-complexity Subband codec, and Opus codec. The foregoing list is not intended to be exhaustive and one or more other audio and/or BT codecs may be used. In some embodiments, the audio frames 510 can be generated at a first rate 520 (e.g., one audio frame every 20 milliseconds). In some embodiments, the first rate 520 can be set such that one audio frame is generated every 7.5-25 milliseconds.

At block 406, a check is made whether or not enough audio frames 510 have been generated to form a burst of audio frames 540. In some embodiments, a burst of audio frames 540 can include between two and four audio frames (e.g., Frames 1-3). Upon determining that enough audio frames 510 have been generated to form a burst of audio frames 540, at block 408, a burst of audio frames 540 is transmitted to the audio playback device 230. In some embodiments, the burst of audio frames 540 can be transmitted through the wireless link and can be transmitted in accordance with one or more BT profiles. For example, the burst of audio of frames 540 can be transmitted in accordance with the BT Advanced Audio Distribution Profile (A2DP). In some embodiments, the audio playback device 230 can confirm successful transmission of the burst of audio frames 540. For example, the audio playback device 230 can transmit an acknowledgement message through the wireless link to the electronic device 210 upon successfully receiving each audio frame of the burst of audio frames 540. On the other hand, upon determining that not enough audio frames 510 have been generated to form a burst of audio frames 540, the process can return to block 404 where additional audio frames 510 can be generated from the audio data that is available for playback.

After a burst of audio frames 540 has been transmitted to the audio playback device 230, at block 410, a check is made to determine whether or not the audio data corresponds to spatial audio (e.g., static spatial audio and/or dynamic spatial audio). In some embodiments, the electronic device 210 can determine whether or not the audio data corresponds to spatial audio by determining whether or not the audio data is in a spatial audio format such as those described above. In other embodiments, the electronic device 210 can determine whether or not the audio data corresponds to spatial audio based on metadata and other information included with the audio data. In some embodiments, a user of the electronic device 210 can inform the electronic device 210 that the audio data corresponds to spatial audio.

Upon determining that the audio data corresponds to spatial audio data (i.e., yes at block 410), at block 412, the electronic device 210 can detect whether or not the wireless link between the electronic device 210 and the audio playback device 230 is good by measuring an average packet error rate and/or an average received signal strength. In other embodiments, the electronic device 210 can detect whether or not the wireless link between the electronic device 210 and the audio playback device 230 is good based on an indication of the wireless link condition from the audio playback device 230. In some embodiments, the electronic device 210 can detect whether or not the wireless link between the electronic device 210 and the audio playback device 230 is good based on whether tracking data 720 has been received from the audio playback device 230. Upon the electronic device 210 detecting that the wireless link is poor (i.e., no at block 412), the process can return to block 404 where additional audio frames 510 are generated from the audio data that is available for playback. Upon the electronic device 210 detecting that the wireless link is good (i.e., yes at block 412), the process can return to block 308 where the electronic device 210 can again check whether or not the audio playback device 230 includes an orientation detector.

Upon determining that the audio data does not correspond to spatial audio data (i.e., no at block 410), at block 414, the electronic device 210 can determine whether or not instructions have been received by a user to stop playback in the basic audio mode. In other embodiments, the electronic device 210 can determine whether or not conditions external to the electronic device 210 inhibit the electronic device 210 from continuing playback in the basic audio mode. For example, a stream of audio data being transmitted to the electronic device 210 from an external source may be interrupted by a poor wireless connection between the electronic device 210 and the external source. In further embodiments, the electronic device 210 can determine whether or not additional audio data is available for playback. For example, the electronic device 210 can determine whether or not additional audio data has been transferred to the electronic device 210 from an external source and/or whether or not additional audio data has been generated with the electronic device 210. Upon determining that playback should continue in the basic audio mode, the process can return to block 404 where additional audio frames 510 can be generated from the audio data that is available for playback. On the other hand, upon determining that playback cannot or should not stay in the basic audio mode, the process can return to block 302 where the electronic device 210 can again check whether or not it is connected to the audio playback device 230.

In some embodiments, while the electronic device 210 is in the basic audio mode, additional audio frames 510 can continue to be generated from the audio data that is available for playback, additional bursts of audio frames 570 can continue to be formed from the additional audio frames 510 that are generated, and the additional bursts of audio frames 570 can continue to be transmitted to the audio playback device 230. In some embodiments, the bursts of audio frames 540, 570 can be transmitted to the audio playback device 230 at a second rate 550 (e.g., one burst of audio frames every 60 milliseconds). In some embodiments, the second rate 550 can be set such that a burst of audio frames is transmitted every 45-75 milliseconds. In the basic audio mode, by buffering a first amount of audio and transmitting bursts of audio frames at a rate slower than a rate at which the audio frames are generated, playback interruptions can be minimized and communication throughput of the electronic device can be improved. For example, the electronic device 210 may use the time between transfers of bursts of audio frames to connect to other devices, collect sensor data from input/output devices, and perform WiFi activities in the 2.4 Gigahertz (GHz) band.

FIGS. 6 and 7 respectively illustrate an embodiment of an example process 600 and operation 700 of a dynamic spatial audio mode according to some aspects. The process 600 and operation 700 can be implemented by system 200. In some embodiments, the process 600 and operation 700 can be implemented by the electronic device 210 or the audio playback device 230. In other embodiments, the process 600 and operation 700 can be implemented by both the electronic 210 and the audio playback device 230. The process 600 and operation 700 can be implemented in software or hardware or any combination thereof.

As shown in FIG. 6, in the dynamic spatial audio mode 600, at block 602, a buffer such as buffer 246 in the audio playback device 230 is set. In some embodiments, the buffer 246 can be set to buffer a second amount of audio 740. In some embodiments, the second amount of audio 740 can be set such that between 0.02 seconds (20 milliseconds) and 0.10 seconds (100 milliseconds) of audio can be buffered.

At block 604, audio frames 710 are generated from the audio data that is available for playback. In some embodiments, the audio frames 710 can be generated based on one or more audio encoder/decoders (i.e., audio codecs) such as one or more BT codecs. Examples of such codecs include the Qualcomm® aptX® codec, Qualcomm® aptX® Low Latency codec, Qualcomm® aptX® High Definition codec, Sony® LDAC codec, AAC, Samsung® Ultra High Quality codec, and Low-complexity Subband codec, Modified Low-complexity Subband codec, and Opus codec. The foregoing list is not intended to be exhaustive and one or more other audio and/or BT codecs may be used. In some embodiments, the audio frames 710 can be generated at the first rate 520 (e.g., one audio frame every 20 milliseconds). In some embodiments, the first rate 520 can be set such that one audio frame is generated every 7.5-25 milliseconds.

At block 606, the audio playback device 230 is pinged. In some embodiments, the electronic device 210 pings the audio playback device 230 by transferring an audio frame (e.g., Frame 1, Frame 2, Frame 3, etc.) or an empty frame to the audio playback device 230. In some embodiments, the audio frame and the empty frame can be transmitted through the wireless link and can be transmitted in accordance with one or more BT profiles. For example, the audio frame and the empty frame can be transmitted in accordance with the BT A2DP. In other embodiments, the audio frame and the empty frame can be transmitted through the wireless link and can be transmitted in accordance with one or more modified BT profiles. For example, the audio frame and the empty frame can be transmitted in accordance a modified BT A2DP. In some embodiments, in response to receiving an audio frame or an empty frame, the audio playback device 230 can send tracking data 720 such as IMU data to the electronic device 210. The tracking data 720 can confirm successful transmission of the audio frame and the empty frame. For example, the audio playback device 230 can transmit tracking data 720 through the wireless link to the electronic device 210 upon successfully receiving each audio frame or empty frame. In some embodiments, the audio playback device 230 can generate the tracking data 720 with the orientation detection circuitry 244 of the audio playback device 230. In some embodiments, the tracking data 720 can represent a user's head movements. In some embodiments, the tracking data 720 can be generated at a fourth rate 722 (e.g., tracking data generated every 10 milliseconds). In some embodiments, the fourth rate 722 can be set such that tracking data is generated every 5-10 milliseconds. In some embodiments, in response to receiving tracking data 720, the electronic device 210 can transmit an acknowledgement message to the audio playback device 230 and the audio playback device 230 can send additional tracking data 720.

At blocks 608, 610, and 612, a check is made whether or not a condition associated with the audio playback device 230 exists. For example, at block 608, a check is made whether or not the tracking data 720 has been received from the audio playback device 230; at block 610, a check is made whether or not the wireless link between the electronic device 210 and the audio playback device 230 is good; and, at block 612, a check is made whether or not the buffer 246 is empty. In some embodiments, the electronic device 210 can detect whether or not the wireless link between the electronic device 210 and the audio playback device 230 is good by measuring an average packet error rate and/or an average received signal strength. In other embodiments, the electronic device 210 can detect whether or not the wireless link between the electronic device 210 and the audio playback device 230 is good based on an indication of the wireless link condition from the audio playback device 230. In some embodiments, the electronic device 210 can detect whether or not the wireless link between the electronic device 210 and the audio playback device 230 is good based on whether tracking data 720 has been received from the audio playback device 230. In some embodiments, the electronic device 210 can detect whether or not the buffer 246 is empty based on an indication that the buffer 246 is empty from the audio playback device 230. In some embodiments, the electronic device 210 can detect whether or not the buffer 246 is empty by comparing a current amount of audio buffered to the second amount of audio 740. In some embodiments, the audio playback device 230 can send data and other information that indicates the current amount of audio buffered. In other embodiments, the electronic device 210 can request from the audio playback device 230 the current amount of audio buffered. In some embodiments, the electronic device 210 can determine that the buffer 246 is empty if the current amount of audio is less than a predetermined percentage of the second amount of audio 740. In some embodiments, the predetermined percentage is 10%. Upon the electronic device 210 detecting a condition exists (e.g., tracking data has not been received, the wireless link is poor, and/or the buffer 246 is empty), the electronic device 210 can switch to the basic audio mode (i.e., the process can return to block 310 where playback continues in the basic audio mode).

Upon the electronic device 210 determining that a condition does not exist (e.g., tracking data has been received, the wireless link is good, and/or the buffer 246 is not empty), at block 614, a check can be made to determine whether or not the electronic device 210 can stay in the dynamic spatial audio mode. In some embodiments, the electronic device 210 can determine whether or not instructions have been received by a user to stop playback in the dynamic spatial audio mode. In other embodiments, the electronic device 210 can determine whether or not conditions external to the electronic device 210 inhibit the electronic device 210 from continuing playback in the dynamic spatial audio mode. For example, a stream of audio data being transmitted to the electronic device 210 from an external source may be interrupted. In other embodiments, the electronic device 210 can determine whether or not additional audio data is available for playback. For example, the electronic device 210 can determine whether or not additional audio data has been transferred to the electronic device 210 from an external source and/or whether or not additional audio data has been generated with the electronic device 210. Upon determining that playback should continue in the dynamic spatial audio mode, the process can return to block 606 where the audio playback device 606 can be pinged with additional audio frames 510 or empty frames. On the other hand, upon determining that playback cannot or should not continue in the dynamic spatial audio mode, the process can return to block 302 where the electronic device 210 can again check whether or not it is connected to the audio playback device 230.

In some embodiments, while the electronic device 210 is in the dynamic spatial audio mode, additional audio frames 710 can continue to be generated from the audio data that is available for playback and the audio playback device 230 can be pinged with the additional audio frames 710 or empty frames. In some embodiments, audio playback device 230 can be pinged at a third rate 732 (e.g., pinging the audio playback device 230 with an audio frame or empty frame every 15 milliseconds). In some embodiments, the third rate 732 can be set such that the tracking data generated at the fourth rate 722 can be sent to the electronic device 210 in response to every ping sent by the electronic device 210 to the audio playback device 230. For example, the third rate 732 can be set between 15-25 milliseconds. In some embodiments, the electronic device 210 can ping the audio playback device 230 with an empty frame if an audio frame 710 is not available. For example, the electronic device 230 can ping the audio playback device 230 after a first audio frame is generated and before a second audio frame is generated. In some embodiments, the electronic device 210 can ping the audio playback device 230 with an audio frame or an empty frame if tracking data is not available. For example, the electronic device 230 can ping the audio playback device 230 after first tracking data is generated and before second tracking data is generated. In some embodiments, the audio playback device 230 can send tracking data 720 in response to receiving an acknowledgement message from the electronic device 210. In the dynamic spatial audio mode, by buffering a second amount of audio and pinging an audio frame or empty at a rate faster than a rate at which the audio frames are generated and at a rate slower than a rate which the tracking data is generated, playback synchronization can be improved, playback interruptions can be minimized, and communication throughput of the electronic device can be improved. For example, the electronic device 210 may use the time between pings to connect to other devices, collect sensor data from input/output devices, and perform WiFi activities in the 2.4 Gigahertz (GHz) band.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present disclosure as claimed has been specifically disclosed by embodiments and optional features, modification, and variation of the concepts herein disclosed may be resorted to by those skilled in the art, and that such modifications and variations are considered to be within the scope of this invention as defined by the appended claims.

Specific details are given in the foregoing description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for providing dynamic spatial audio comprising:
receiving audio data;
switching to a dynamic spatial audio mode;
while in the dynamic spatial audio mode:
set a buffer in the audio playback device to buffer a first amount of audio;
generating first audio frames from the received audio data;
transmitting the audio frames to an audio playback device using a wireless link; and
detecting at least one condition associated with the audio playback device;
in response to detecting the at least one condition associated with the audio playback device, switching to a basic audio mode;
while in the basic audio mode:
set the buffer in the audio playback device to buffer a second amount of audio more than the first amount of audio;
generating second audio frames from the received audio data; and
transmitting the second audio frames to the audio playback device using the wireless link.

2. The method of claim 1, wherein the at least one condition corresponds to tracking data not being received, a poor wireless link, or an empty buffer.

3. The method of claim 1, wherein the audio playback device comprises orientation detection circuitry.

4. The method of claim 1, wherein the audio playback device comprises at least one earbud.

5. The method of claim 1, wherein the wireless link comprises at least one of a Bluetooth basic rate/enhanced data rate link and a Bluetooth low energy audio link.

6. The method of claim 1, wherein the first audio frames are generated in the dynamic spatial audio mode at a first predetermined rate, and wherein transmitting the audio frames to the audio playback device using the wireless link in the dynamic spatial audio mode comprises pinging the audio playback device as at a second predetermined rate faster than the first predetermined rate.

7. The method of claim 1, wherein the first audio frames are generated in the dynamic spatial audio mode at a first predetermined rate, and wherein transmitting the audio signal to the audio playback device using the wireless link in the basic audio mode comprises transmitting bursts of audio frames to the audio playback device at a third predetermined rate that is slower than the first predetermined rate.

8. A system for providing dynamic spatial audio comprising:
one or more processors; and
one or more memories, the one or more memories storing instructions which, when executed by the one or more processors, cause the one or more processors to perform operations comprising:
receiving audio data;
switching to a dynamic spatial audio mode;
while in the dynamic spatial audio mode:
set a buffer in the audio playback device to buffer a first amount of audio;
generating first audio frames from the received audio data;
transmitting the audio frames to an audio playback device using a wireless link; and
detecting at least one condition associated with the audio playback device;
in response to detecting the at least one condition associated with the audio playback device, switching to a basic audio mode;
while in the basic audio mode:
set the buffer in the audio playback device to buffer a second amount of audio more than the first amount of audio;
generating second audio frames from the received audio data; and
transmitting the second audio frames to the audio playback device using the wireless link.

9. The system of claim 8, wherein the at least one condition corresponds to tracking data not being received, a poor wireless link, or an empty buffer.

10. The system of claim 8, wherein the audio playback device comprises orientation detection circuitry.

11. The system of claim 8, wherein the audio playback device comprises at least one earbud.

12. The system of claim 8, wherein the wireless link comprises at least one of a Bluetooth basic rate/enhanced data rate link and a Bluetooth low energy audio link.

13. The system of claim 8, wherein the first audio frames are generated in the dynamic spatial audio mode at a first predetermined rate, and wherein transmitting the audio frames to the audio playback device using the wireless link in the dynamic spatial audio mode comprises pinging the audio playback device as at a second predetermined rate faster than the first predetermined rate.

14. The system of claim 8, wherein the first audio frames are generated in the dynamic spatial audio mode at a first predetermined rate, and wherein transmitting the audio signal to the audio playback device using the wireless link in the basic audio mode comprises transmitting bursts of audio frames to the audio playback device at a third predetermined rate that is slower than the first predetermined rate.

15. One or more non-transitory computer-readable media storing computer-readable instructions that, when executed by one or more processors, cause the one or more processors to perform operations including:
receiving audio data;
switching to a dynamic spatial audio mode;
while in the dynamic spatial audio mode:
set a buffer in the audio playback device to buffer a first amount of audio;
generating first audio frames from the received audio data;
transmitting the audio frames to an audio playback device using a wireless link; and
detecting at least one condition associated with the audio playback device;
in response to detecting the at least one condition associated with the audio playback device, switching to a basic audio mode;
while in the basic audio mode:
set the buffer in the audio playback device to buffer a second amount of audio more than the first amount of audio;
generating second audio frames from the received audio data; and
transmitting the second audio frames to the audio playback device using the wireless link.

16. The one or more non-transitory computer-readable media of claim 15, wherein the at least one condition corresponds to tracking data not being received, a poor wireless link, or an empty buffer.

17. The one or more non-transitory computer-readable media of claim 15, wherein the audio playback device comprises orientation detection circuitry and at least one earbud.

18. The one or more non-transitory computer-readable media of claim 15, wherein the wireless link comprises at least one of a Bluetooth basic rate/enhanced data rate link and a Bluetooth low energy audio link.

19. The one or more non-transitory computer-readable media of claim 15, wherein the first audio frames are generated in the dynamic spatial audio mode at a first predetermined rate, and wherein transmitting the audio frames to the audio playback device using the wireless link in the dynamic spatial audio mode comprises pinging the audio playback device as at a second predetermined rate faster than the first predetermined rate.

20. The one or more non-transitory computer-readable media of claim 15, wherein the first audio frames are generated in the dynamic spatial audio mode at a first predetermined rate, and wherein transmitting the audio signal to the audio playback device using the wireless link in the basic audio mode comprises transmitting bursts of audio frames to the audio playback device at a third predetermined rate that is slower than the first predetermined rate.
